(19) United States
(12) Patent Application Publication
(10) Pub. No.: US 2010/0062893 A1
(43) Pub. Date: Mar. 11, 2010

(54) Compact Multiple-Ratio Transmission Device

(76) Inventor: Roumen Antonov, Paris (FR)

Correspondence Address: KENYON & KENYON LLP, ONE BROADWAY, NEW YORK, NY, 10004, US

(21) Appl. No.: 12/311,399

(22) PCT Filed: Sep. 7, 2007
(86) PCT No.: PCT/FR2007/001445

§ 371 Date: Nov. 16, 2009

(30) Foreign Application Priority Data
Sep. 26, 2006 (FR) 06 084232

(51) Int. Cl. F16H 37/04; F16H 3/54; F16H 3/66

(52) U.S. Cl. 475/275; 475/271

(57) ABSTRACT

The invention relates to a compact multiple-ratio transmission device. According to the invention, three planetary gearsets (TP1, TP2, TP3) use selective coupling means (B1, B2, B3, BR, C4, C5, C6) each to supply a local direct drive and at least one other transmission ratio. Said planetary gearsets belong to three different power paths (8a, 8b and 8c) between an upstream rotary member (2) and a downstream rotary member (4). Upstream gear transfer elements (TR1, TR2) are operably mounted between the upstream rotary member (2) and two “downstream” planetary gearsets (TP1, TP2). A downstream gear transfer element (TR3) is operably mounted between the third “upstream” planetary gearset (TP3) and the downstream rotary member (4). The upstream planetary gearset (TP3) is mounted about the axis (A2) of the upstream rotary member (2). The invention relates to the use of same to produce a compact, economical transmission with good overall performance and good ratio shifting, enabling ratio shifting without interrupting the power transmission.

### TECHNICAL FIELD

This invention relates to a multiple-ratio transmission device, in particular of the constant-mesh type capable of gear changes without interrupting the power transmission. This invention relates in particular to automatic or sequential gearboxes.

### STATE OF THE PRIOR ART

In order to produce automatic or sequential gearboxes for automotive vehicles, gearboxes produced using planetary gear sets, for example epicyclic gear sets, are known.

EP 0 434 525 describes a gearbox using a double planetary gearset, of the epicyclic or Ravigneaux type, and five coupling devices (two brakes and three clutches) to produce six forward gears and one reverse gear. Each ratio is obtained by jointly activating two of the five couplings.

However, this type of gearbox, which is currently installed in a certain number of vehicles, has drawbacks. The joint activation of two couplings necessitates a synchronization of their control. This type of transmission cannot comfortably “skip a gear”, i.e. shift from one gear to another that is not the gear immediately below or above it. The device is most often used in series with an upstream clutch or torque converter in order to make it possible to progressively set the vehicle in motion from stationary.

WO 2005/050060 describes a transmission device with five forward gears plus reverse gear, comprising two planetary gear sets mounted along two parallel layshafts. On the input shaft, a single driving transfer pinion meshes with two driven transfer pinions each situated on one of the layshafts and each driving the input element of a planetary gear set.

Each planetary gear set comprises a clutch producing a local direct drive, and two epicyclic gear sets each delivering one transmission ratio by locking one of its elements using a respective brake. The two epicyclic gear sets of one of the planetary gear sets each comprising at least one cascade of two planets between the ring gear and the sun wheel. In other words, one of the planets meshes with the ring gear, the other with the sun wheel, and the two planets mesh with each other. One gear of this planetary gear set is a reverse gear. As many local direct drives are therefore produced as there are layshafts and an epicyclic gear set is needed for each gear except two, in other words four epicyclic gear sets for six gears in all (five forward and one reverse). For each gear other than the local direct drives, power is transmitted by one epicyclic gear set and two meshing transfers.

This type of device also has certain drawbacks. The space requirement of the device is large, in particular due to the two planetary gear sets each mounted on a layshaft.

The invention aims to overcome the drawbacks of the prior art or enhance its advantages, in particular by improving its capacities and performance compared with the currently known transmissions.

The invention seeks in particular to achieve at least one of the following objectives:
to limit or reduce the space required by the device, or adapt it to its environment,
to obtain a larger number of gears,
to obtain better flexibility of design in the choice of gears to be produced,
to simplify and make reliable the selection and control of the gears,
to improve operating reliability and flexibility,
to improve the transmission efficiency, or
to limit or reduce the number of pinions or gear teeth to be produced.

### DISCLOSURE OF THE INVENTION

To this end, the invention proposes a multiple-ratio transmission device comprising:
a frame;
an upstream rotary element and a downstream rotary element;
a downstream planetary gear set and an upstream planetary gear set, non-coaxial and belonging to two different power paths between the upstream rotary element and the downstream rotary element;
an upstream meshing transfer, interposed between the upstream rotary element and the downstream planetary gear set;
a downstream meshing transfer interposed between the upstream planetary gear set and the downstream rotary element; and
selective-coupling means to make each planetary gear set operate selectively in local direct drive or according to at least one different transmission ratio;
   characterized in that the second planetary gear set is mounted about the axis of the upstream rotary element.

A planetary gear set is called “upstream” when it is upstream of the associated meshing transfer, which is then “downstream”, and the planetary gear set is called “downstream” when it is downstream of the associated meshing transfer, which is then “upstream”.

The invention makes it possible in particular to obtain a large number of ratios while limiting the space requirement and complexity. In fact, the direct drives of the two planetary gear sets easily deliver different transmission ratios. The invention also offers the possibility of producing several local direct drives without having to provide a corresponding number of layshafts, and even, as will be seen later, without any layshaft at all, according to at least one embodiment. Production is simplified, and the number of gear ratios obtained with relatively few meshing is increased. The number of pinions and the number of shafts are reduced. The weight, space requirement and cost are therefore also reduced. A device according to the invention makes it possible to produce a gearbox that is particularly compact, in particular in length along the direction of the shafts of the upstream and downstream rotary elements. By way of example, a gearbox designed for a torque of 250 Nm can be produced with a longitudinal space requirement of less than 350 mm, as against at least 380 to 390 mm for a standard gearbox as described in EP 0 434 525 B1, which has an equivalent number of ratios.

Transmission ratios can be produced by planetary gear sets operating with a local ratio other than 1:1. These ratios are preferably the ratios called “low” or “short” of the device according to the invention (that is, ratios for which the speed of the downstream element is lower for a given speed of the upstream element, by comparison with those called “high” or “long” ratios). This is very advantageous for control, as will be seen later.

With regard to the spatial arrangement, at least one of the transfers can be placed axially between at least one of the planetary gear sets and a connecting end of the upstream element, said connecting end for mechanical connection of the upstream element to a motive power source.

The two transfers can be arranged in two planes perpendicular to the axis of the upstream rotary element, and the two planetary gear sets can be accommodated spatially between these two planes.

The upstream transfer can comprise a driving toothed wheel integral with the upstream rotary element, and the downstream planetary gear set can be mounted about an axis of a first layshaft. The output element of the downstream planetary gear set is integral with the first layshaft.

According to a first embodiment, the downstream transfer then comprises a driven toothed wheel integral with the first layshaft.

According to a second embodiment, the downstream transfer comprises a driving toothed wheel, integral with the output element of the upstream planetary gear set. This driving toothed wheel, mounted about the axis of the upstream rotary element, is connected, preferably by an intermediate chain or gear, to a driven toothed wheel integral with the downstream rotary element.

According to a third embodiment, the downstream planetary gear set is no longer mounted about a layshaft, but about the axis of the downstream rotary element, and the downstream transfer comprises a driven toothed wheel integral with the downstream rotary element. This embodiment does not require a layshaft.

Preferably, the device according to the invention comprises, between the upstream rotary element and the downstream rotary element, at least one third power path comprising a second upstream or downstream planetary gear set, having an axis different from those of the two above-mentioned planetary gear sets, or conversely having the same axis as one of the two above-mentioned planetary gear sets. This additional planetary gear set is operatively mounted in series with its own meshing transfer, defining between the upstream rotary element and the downstream rotary element, when the additional planetary gear set is in a local direct drive state, a transmission ratio different from each of those defined by the two above-mentioned meshing transfers when their respective planetary gear set is in a local direct drive state. The local direct drive of this additional planetary gear set thus delivers a new overall gear ratio that is different from the other two obtained by the direct drives of the other two planetary gear sets.

The downstream planetary gear set can be mounted about an axis of a first layshaft (as for the first and second embodiments), and the additional planetary gear set can be a downstream planetary gear set mounted about an axis of a second layshaft, the first and the second planetary gear sets being connected, at least indirectly, respectively to the first and second layshafts, the first and second layshafts being connected to the downstream rotary element by meshing. In particular, the first layshaft and the second layshaft can each support a pinion called a “meshing pinion”, while being connected for common rotation therewith. The two meshing pinions mesh typically with a single toothed wheel on the downstream rotary element.

The first and the second upstream transfers, associated respectively with the first and second downstream planetary gear sets, can comprise a common toothed wheel on the upstream rotary element, meshing with two pinions each mounted about the respective axis of the first and second downstream planetary gear sets. In particular, the common toothed wheel can comprise two sets of teeth of different diameters, each meshing with a respective one of the two pinions. It is accordingly possible both to reduce the space requirement perpendicularly to the axes and to make a more accurate tuning of the transfer ratios of the first and second upstream transfers and/or the spacing between these ratios.

The transfers can be arranged in two planes perpendicular to the axis of the upstream rotary element, and the planetary gear sets can be accommodated spatially between these two planes.

The three planetary gear sets can comprise:
a planetary gear set, preferably one of the downstream gear sets, the input of which is connected to a sun wheel and the output of which is connected to a planet carrier, this gear ratio set being capable of a local direct drive in order to produce a sixth gear ratio, and a gear reduction by locking a ring gear in order to produce a second gear ratio;
another planetary gear set, preferably the upstream gear set, the input of which is connected to a sun wheel and the output of which is connected to a planet carrier, this other gear set being capable of a local direct drive in order to produce a fourth gear ratio, and a gear reduction by locking a ring gear in order to produce a first gear ratio; and
yet another a planetary gear set, preferably the other downstream gear set, the input of which is connected to a ring gear and the output of which is connected to a planet carrier, this gear set being capable of a local direct drive in order to produce a fifth gear ratio, and a gear reduction by locking a sun wheel in order to produce a third gear ratio;
the gear ratios increasing in length from first to sixth gear.

One of the planetary gear sets can comprise a sun wheel connected to the input, a ring gear connected to the output, and a planet carrier capable of being selectively locked in order to produce a reverse gear.

According to another feature of the invention, one of the planetary gear sets can comprise at least two epicyclic gear sets having a common input and a common output. These two epicyclic gear sets are then mechanically in parallel between the input and the output of the planetary gear set.

In one embodiment:

a first of these epicyclic gear sets comprises a planet carrier free in relation to the common input and to the common output and capable of being immobilized in relation to the frame by means of one of the selective-coupling means for producing a reverse gear,

a second of these epicyclic gear sets having a planet carrier connected constantly to one of said common input and output.

In addition to the reverse gear, such a planetary gear set can produce two forward gear ratios, each by activating the respective selective-coupling means. Preferably, said one of the planetary gear sets is the upstream planetary gear set, the first and second epicyclic gear sets have sun wheels connected to the common input and integral with the upstream rotary element, the planet carrier of the second epicyclic gear set being constantly connected to the common output and to a ring gear of the first epicyclic gear set.

According to another feature of the invention, two planetary gear sets can be aligned with each other, approximately perpendicularly to their axes which are different from each other and parallel to each other.

Preferably, for at least one of the planetary gear sets, the selective-coupling means associated with the gear set are centred about the axis of the gear set and are all at approximately the same distance from the axis.

At least one of the planetary gear sets can comprise an epicyclic gear set comprising:
a planet carrier connected constantly, at least indirectly, to a first of the upstream and downstream rotary elements, and capable of being selectively connected, at least indirectly, to the second of said upstream and downstream rotary elements by one of the selective-coupling means, thus forming a direct local drive;
a sun wheel and a ring gear, one of which is connected constantly to said second rotary element; and the other of which can be selectively connected to the frame by one of the selective-coupling means.

Each transmission ratio can be produced by closing a single selective-coupling means of one of the planetary gear sets and by opening or maintaining in an open state the other selective-coupling means of the transmission device.

The selective-coupling means can be of the progressive type and capable of ensuring progressive adaptation between the speed of rotation of a vehicle engine and the speed of the vehicle, in particular for setting the vehicle in motion from stationary by at least one of the selective-coupling means.

According to another feature of the invention, the shortest of the ratios obtained by the direct local drives can be longer than the longest of the ratios obtained by selective-coupling between the frame and an element of a planetary gear set.

### DESCRIPTION OF THE FIGURES AND EMBODIMENTS

Other features and advantages of the invention will become apparent from the detailed description of embodiments that are in no way limiting, and the attached drawings, in which:

FIGS. 1, 3 and 5 show diagrammatically a first, a second and a third embodiment of the invention, each providing six gear ratios plus a reverse gear, and comprising three planetary gear sets which are shown only in half-view;

FIGS. 2 and 4 are end views showing diagrammatically the organisation of the different axes of the first embodiment according to FIG. 1 and respectively of the second embodiment according to FIG. 3; and

FIG. 6 is an axial cross-section of a detail of the embodiment in FIG. 5.

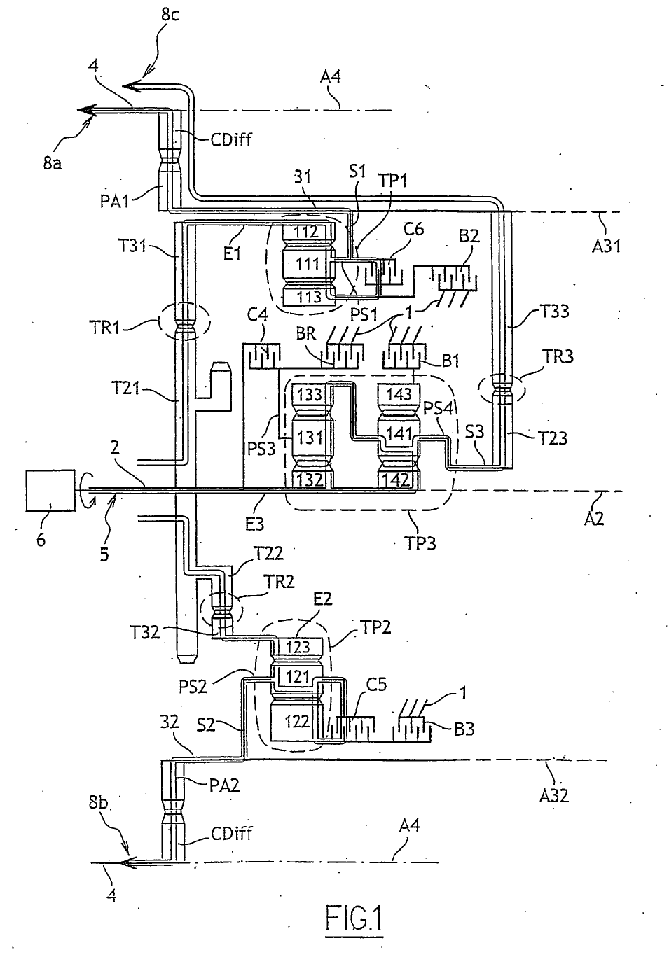

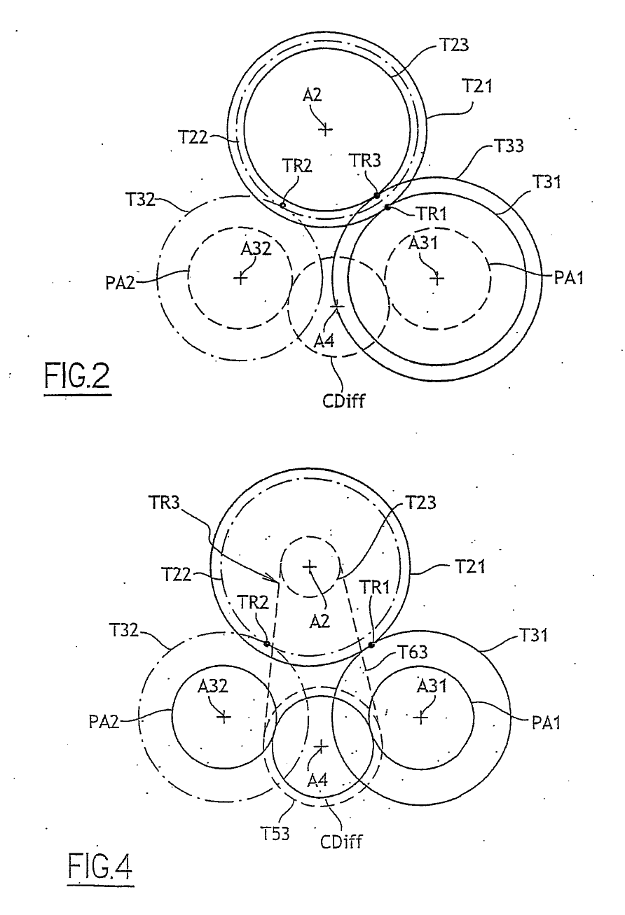

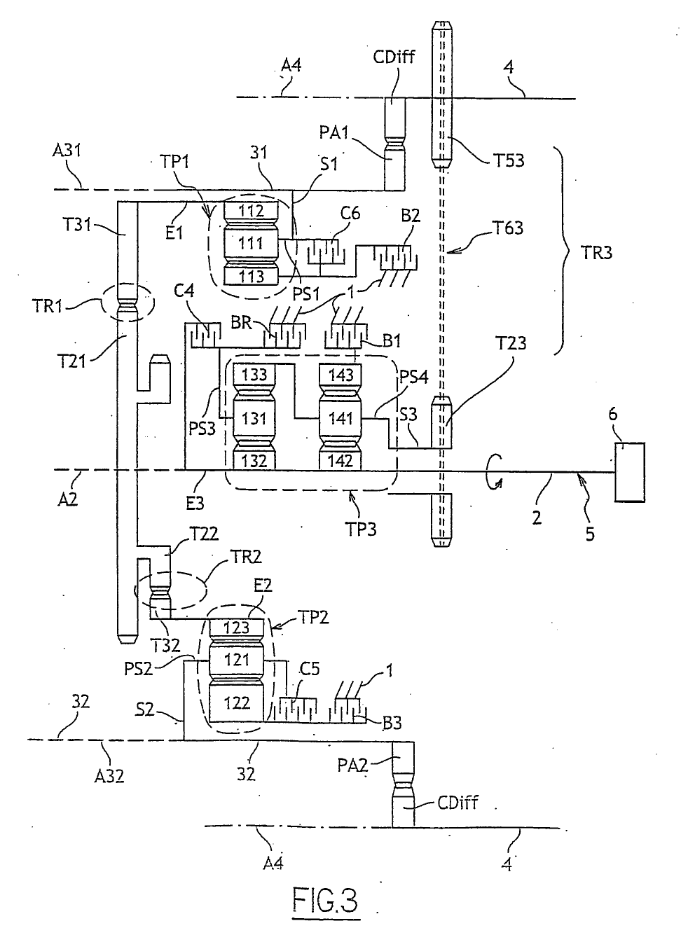

In the first embodiment in FIGS. 1 and 2 and in the second embodiment in FIGS. 3 and 4, the transmission device according to the invention comprises an upstream rotary element 2 formed by an input shaft. Typically, when the transmission device is installed, the upstream rotary element 2 is constantly connected to a motive power source 6 such as an automobile engine, in particular an internal combustion engine, without interposing a clutch or other variable coupling device such as a torque converter. In other words, the typical link between the shaft 2 and the engine is such that any rotation of a drive shaft of the engine is necessarily accompanied by a rotation of the shaft 2, and the shaft 2 is stationary only if the engine shaft is immobile.

A downstream rotary element 4, formed here by an output shaft, is intended to be connected to the driving wheels of a motor vehicle via a differential, or can itself form an input shaft of this differential. The connection between the shaft 4 and the driving wheels of the vehicle is typically such that at least one driving wheel rotates when the shaft 4 rotates. The transmission device moreover comprises a first and a second layshaft 31, 32, extending along a first and respectively a second intermediate axis A31, A32 which are both parallel to the axes A2 and A4 of the upstream rotary element 2 and of the downstream rotary element 4, but not coaxial with them. For the sake of clarity, in FIGS. 1 and 3 the output shaft 4 is shown both at the top and at the bottom, and the two intermediate axes A31 and A32 are shown in the same plane as that of the axes A2 and A4 of elements 2 and 4 (i.e. the plane in FIG. 1 or FIG. 3). In reality, the axes A2 and A4 and the two intermediate axes A31 and A32 are at the four vertices of a quadrilateral, as shown in FIGS. 2 and 4.

At least when it is operating in its “low” ratios, the device is used to step down (i.e. reduce) the speed of rotation of the upstream element 2 to a lower speed of the downstream element 4, and consequently increase the transmitted torque.

Three planetary gear sets TP1, TP2 and TP3 are arranged respectively about the intermediate axes A31 and A32 and the axis A2.

The transmission device connects the upstream rotary element 2 to the downstream rotary element 4 along three power paths 8a, 8b and 8c represented by arrows in FIG. 1. The paths 8a, 8b, 8c are operatively in parallel between the rotary elements 2 and 4. Each path 8a, 8b or 8c passes respectively through one of the three planetary gear sets TP1, TP2 and TP3. The first power path 8a passe through a first meshing transfer TR1 mounted operatively in series between the upstream rotary element 2 and the first planetary gear set TP1. The second power path 8b passes through a second meshing transfer TR2 mounted operatively in series between the upstream rotary element 2 and a second planetary gear set TP2. The third power path 8c passes through a third meshing transfer TR3 mounted operatively in series between the third planetary gear set TP3 and the downstream rotary element 4.

The planetary gear sets TP1, TP2 and TP3 are approximately aligned between two planes perpendicular to the axes A2, A31, A32, A4, one of these planes containing the transfers TR1 and TR2, the other the transfer TR3. Each planetary gear set TP1, TP2, TP3 is situated radially beyond the other two, such that the axial space requirement of the three gear sets considered together is substantially the same as that of each of them.

The transfer TR1 comprises a driving pinion T21 integral with the upstream, rotary element 2 and meshing with a driven pinion T31 arranged about the first intermediate axis A31 while being integral with the input element El of the first planetary gear set TP1, but free to rotate in relation to the layshaft 31. The transfer TR1 is called “upstream” as it is upstream of the associated planetary gear set TP1, relative to the energy flow from the motive power source 6. The planetary gear set TP1 is called “downstream” as it is downstream of the transfer TR1.

The transfer TR2 comprises a driving pinion T22 integral with the upstream rotary element 2 and meshing with a driven pinion T32 arranged about the second intermediate axis A32 while being integral with the input element E2 of the second planetary gear set TP2, but free to rotate in relation to the layshaft 32. The transfer TR2 and the planetary gear set TP2 are therefore an upstream transfer and a downstream planetary gear set, like TR1 and TP1 respectively.

The driving pinions T21 and T22 belong to a common toothed wheel, but have different toothing diameters. The ratios of the transfers TR1 and TR2 are different. The intermediate axes A31 and A32 are generally at different distances from the input shaft 2. Using two integral transfer pinions instead of a single one that would mesh with the two driven pinions such as T31 and T32 makes it possible to bring each intermediate axis A31 and A32 as close as possible to the axis A2, taking account of the radial space requirement of the planetary gear sets, while improving the possibilities for accurately selecting the two transfer ratio values and the spacing between these two values.

The output element S1, S2 of the planetary gear set TP1, TP2 respectively has a drive connection to the first layshaft 31 or the second layshaft 32 respectively. Typically, as shown, the output element S1 is integral with the first layshaft 31 and the output element S2 is integral with the second layshaft 32. Each layshaft 31, 32 is itself rotatably integral with an output pinion PA1 or PA2 respectively. The pinions PA1 and PA2 mesh with a ring gear CDiff integral with the downstream rotary element 4. In this example, the ring gear CDiff is the ring gear driving the cage of a standard differential for driving the driving wheels of the vehicle.

The meshing transfer TR3 is mounted operatively between an output element S3 of the planetary gear set TP3 and the output shaft 4. The input shaft 2 is constantly connected for common rotation with an input element E3 of the planetary gear set TP3. The output element S3 is constantly connected for common rotation with a driving pinion T23 of the transfer TR3. The driving transfer pinion T23 and the output element S3 are coaxial with the upstream element 2 while being capable of rotating at a different speed from the latter. The transfer TR3 is called “downstream” as it is downstream of the associated planetary gear set TP3, which is therefore called “upstream”.

In the first embodiment of the invention, shown in FIGS. 1 and 2, the driving pinion T23 meshes with a driven pinion T33. The driven pinion T33 is connected for common rotation with the layshaft A31 such that when the planetary gear set TP3 is active, the driving pinion T23 transmits the rotational movement to the output shaft 4 via the layshaft A31, the pinion PA1 and the ring gear CDiff. In the example shown, the shaft 4 is connected to the driving wheels by its extremity situated on the left in FIG. 1, i.e. on the same side as the extremity 5 connecting the upstream shaft 2 to the motive power source 6. The architecture is thus considerably simplified. The driving pinions T21 and T22 of the first and second transfers TR1 and TR2 are placed axially along the axis A2 between on the one hand the planetary gear sets TP1, TP2 and TP3 and on the other hand the extremity 5 providing mechanically connection of the upstream element 2 to the motive power source 6.

In the second embodiment of the invention, shown in FIGS. 3 and 4, and which will be described only in respect of its differences from the embodiment in FIGS. 1 and 2, the driven transfer pinion T53 of the third transfer TR3 is coaxial with the downstream rotary element 4, and connected for common rotation with the latter. The driving T23 and driven T53 pinions are chain wheels. The transfer TR3 comprises a chain T63 which, with a chosen transmission ratio, rotatably connects the driving pinion T23 to the driven pinion T53, connected for common rotation with the shaft 4. In this example, the shaft 4 is connected to the driving wheels by its extremity situated on the right in the figures, adjacent to the transfer TR3, and remote from the transfers TR1 and TR2. The extremity 5 connecting the upstream shaft 2 to the motive power source 6 is also situated on the right-hand side, therefore as in the previous example on the same side as connection of the downstream element 4 with the driving wheels of the vehicle. The driving pinion T23 of the third transfer TR3 is thus placed axially along the axis A2 between on the one hand the planetary gear sets TP1, TP2 and TP3 and on the other hand the extremity 5 mechanically connecting the upstream element 2 to the motive power source 6.

In the two embodiments, the respective transfer ratios between the driving pinion T21 (assuming the gear set TP1 operates in direct drive), T22 (assuming the gear set TP2 operates in direct drive) or T23 on the one hand, and the downstream rotary element 4 on the other hand, are different.

More particularly, in the two embodiments, the pinions PA1 and PA2 have identical diameters. The meshing ratios T21/T31 and T22/T32 are different. In the first embodiment, the meshing ratio T23/T33 differs from T21/T31 and T22/T32. In the second embodiment (FIGS. 3 and 4), the ratio T23/T53 differs from T21/T31 as modified by PA1/CDiff and from T22/T32 as modified by PA2/CDiff.

The first and second embodiments of the invention moreover comprise a certain number of selective-coupling devices BR, BR1, B2, B3, C4, C5, C6 which will be described more in detail later. The design is such that each transmission ratio is produced by activation, i.e. placing in a coupled state, of a single one of the selective-coupling means, and deactivation, i.e. placing or maintaining in an uncoupled state all of the other selective-coupling means. The idle (“neutral”) state in which the rotary elements 2 and 4 are independent of each other is obtained by deactivation of all the selective-coupling means.

The different selective-coupling means are produced here in the form of compression friction mechanisms of the wet multi-disc type. These means are called “brakes” when their activation produces the coupling of a mobile element with a fixed frame 1 or any component integral with the latter. These means are called “clutches” when their activation produces the mutual coupling of two rotary elements so that they are rotatably integral with each other.

The coupling means (B2 and C6; B3 and C5; BR, BR1 and C4) associated with each of the planetary gear sets (respectively TP1; TP2; TP3) are centred approximately at the same distance from the axis (respectively A31; A32; A2) of said planetary gear set. Thus, the compactness of the device according to the invention is optimized, and the supply of oil to the coupling means is simplified.

The first planetary gear set TP1 comprises a first epicyclic gear set coaxial with the first intermediate axis A31. This first epicyclic gear set comprises a planet carrier PS1 on which are mounted eccentric planets 111 free to rotate on their own axis in relation to the planet carrier PS1. The planets 111 mesh with a central sun wheel 112 and with a peripheral ring gear 113. The latter is coaxial with the sun wheel 112, the planet carrier PS1 and the axis A31. The central sun wheel 112 is rotatably integral with the input E1 of the planetary gear set TP1 and the driven pinion T31, and is thus constantly connected to one of the upstream and downstream rotary elements, in this case the upstream rotary element 2, by means of the transfer TR1.

The planet carrier PS1 is rotatably integral with the output S1 and therefore with the first layshaft 31. It is thus constantly connected to the other of the upstream and downstream rotary elements, in this case the downstream rotary element 4, by means of the pinion PA1.

A brake B2, mounted operatively between the ring gear 113 and the frame 1, makes it possible to selectively lock and release the rotation of the ring gear 113 relative to the fixed frame 1. When the ring gear 113 is immobilized, the sun wheel 112, driven by the upstream element 2, drives the planet carrier PS1 in a local gear reduction dependent on the geometry of the first epicyclic gear set TP1. The total gear reduction therefore depends on this local gear reduction, as well as on the transfer TR1 and the meshing ratio between PA1 and CDiff. By activating the brake B2 an overall transmission ratio is thus created, forming the second gear (2^{nd}) in the present example.

A clutch C6 mounted operatively between the input E1 and the output S1 of the first planetary gear set TP1 makes it possible to selectively operate the gear set TP1 in local direct drive when the clutch C6 is closed (activated), or to let the input E1 and the output S1 rotate at different speeds when the clutch C6 is open (deactivated), in particular for second-gear operation when the brake B2 is closed. The local direct drive in the first planetary gear set TP1 delivers an overall ratio determined by the ratio of the first transfer TR1 and the ratio PA1/CDiff. In this example, this overall ratio is the sixth gear (6^{th}).

The second planetary gear set TP2 comprises a second epicyclic gear set coaxial with the second intermediate axis A32. This gear set comprises a planet carrier PS2 supporting one or more eccentric planets 121, free to rotate on their own axis in relation to the planet carrier PS2. The planets 121 mesh with a sun wheel 122 and with a peripheral ring gear 123. This latter is coaxial with the central sun wheel 122, with the planet carrier PS2 and with the axis A32.

In this second epicyclic gear set, the ring gear 123 is integral with the input E2, and therefore with the driven transfer pinion T32. The ring gear 123 thus constantly has a drive connection with one of the upstream and downstream rotary elements, in this case the upstream element 2.

The planet carrier PS2 is thus rotatably integral with the output S2 and therefore with the second layshaft 32. The planet carrier PS2 thus constantly has a drive connection with the other of the upstream and downstream rotary elements, that is, the downstream element 4.

A clutch C5 makes it possible to selectively couple and uncouple the sun wheel 122 and the planet carrier PS3 together, and therefore the input E2 and the output S2 together. When the clutch C5 is in a coupled state, the second planetary gear set TP2 is in a local direct drive state between its input E2 and its output S2.

The geometry of the second transfer TR2 and the second output pinion PA2 then delivers an overall transmission ratio, corresponding in this example to fifth gear (5^{th}).

A brake B3, mounted operatively between the sun wheel 122 and the frame 1, makes it possible to selectively lock and release the rotation of the sun wheel 122 relative to the fixed frame 1. When the sun wheel 122 is locked, the rotation of the ring gear 123 drives the planet carrier PS2 in a local gear reduction ratio determined by the geometry of this epicyclic gear set.

When the brake B3 is locked, the geometry of the epicyclic gear set combines with those of the second transfer TR2 and the second output pinion PA2 to give an overall transmission ratio, corresponding in this example to third gear (3^{rd}).

The third planetary gear set TP3 comprises a third and a fourth epicyclic gear set, coaxial with each other and with the axis A2 of the upstream rotary element 2.

These two epicyclic gear sets have a common input E3 and a common output S3. The common input E3 is integral with the upstream element 2. The common output S3 is integral with the driving pinion T23.

The third epicyclic gear set comprises a planet carrier PS3 supporting one or more eccentric planets 131 free to rotate about their own axis in relation to the planet carrier PS3. The planets 131 mesh on the one hand with a central sun wheel 132 and on the other hand with a peripheral ring gear 133. The latter is coaxial with the sun wheel 132 and with the upstream rotary element 2.

The fourth epicyclic gear set comprises a planet carrier PS4 supporting one or more eccentric planets 141 free to rotate about their own axis in relation to the planet carrier PS4. The planets 141 mesh on the one hand with a central sun wheel 142 and on the other hand with a peripheral ring gear 143. The latter is coaxial with the sun wheel 142, the planet carrier PS4 and the upstream rotary element 2.

The central sun wheels 132 and 142 of these third and fourth epicyclic gear sets are both integral with the common input E3, and therefore with the upstream rotary element 2.

The ring gear 133 of the third epicyclic gear set and the planet carrier PS4 of the fourth epicyclic gear set are integral with the common output S3 and therefore the driving pinion T32. The ring gear 133 and the planet carrier PS4 are therefore constantly connected to one of the upstream and downstream rotary elements, in this case the downstream element 4, by means of the transfer TR3.

The planet carrier PS3 of the third epicyclic gear set 131 to 133 is free in relation to the common input E3 and the common output S3, and can be selectively immobilized in relation to the frame 1 by means of one of the selective-coupling means, the brake BR, to produce a reverse gear.

When the planet carrier PS3 is immobilized, the sun wheel 132 connected to the input E3 drives the ring gear 133 in reverse in a geared-down manner, by means of the planets 131 which rotate on themselves. The ring gear 133 then drives the common output S3 and therefore the downstream element 4, thus producing a reverse gear (REV).

The ring gear 143 of the fourth epicyclic gear set is free in relation to the common input E3 and the common output S3 and can be selectively locked and released in rotation relative to the frame 1 by means of one of the selective-coupling means, the brake BR1. When the ring gear 143 is immobilized, the sun wheel 142, connected to the input E3, drives the planet carrier PS4 according to a local gear reduction dependent on the geometry of the epicyclic gear set.

By activating the brake BR1 and releasing the other selective-coupling means 30, an overall transmission ratio is thus created dependent on the geometry of the fourth epicyclic gear set, the third transfer TR3 (and dependent moreover on the geometry of the first output pinion PA1 in the first embodiment). This overall ratio in the present example forms first gear (1^{st}).

Moreover, the clutch C4, forming part of the selective-coupling means, selectively couples and uncouples the input E3 and the output S3 in relation to each other. When the clutch C4 is activated, the planetary gear set TP3 operates in local direct drive providing a transmission ratio, here fourth gear (4^{th}), that depends on the transfer ratio TR3 (and that depends moreover on the meshing ratio PA1-CDiff in the first embodiment).

According to a variant not shown here, the output pinions PA1 and PA2 of the layshafts 31 and 32 can have different dimensions and contribute to determining different ratios.

In the two embodiments described here, the upstream and downstream rotary elements are connected to each other by constant meshing. The gear changes are not carried out by operating synchronizers or positive clutches, but by wet clutches or brakes that allow for smooth transitions between the gears, without interrupting the transmission of power. Control of gear changes is simplified, as no clutch is necessary between the engine of the vehicle and the input element 2. Efficiency is not reduced by a torque converter, as a torque converter is not necessary.

As mentioned above in detail, each transmission ratio is produced by closing a single selective-coupling means of one of the three planetary gear sets TP1, TP2, TP3 and by opening or maintaining in an open state the other selective-coupling means of the transmission device. This simplifies control and allows in a fairly simple manner joint regulation of the pressurization of the hydraulic chamber of the selective-coupling means in the process of closing, and the reduction of pressure in the hydraulic chamber of the selective-coupling means in the process of opening. Such regulation makes it possible to avoid surges on the one hand, and to avoid or limit power flow interruption through the transmission on the other hand.

It is possible to skip one or more gears, simply by releasing the current coupling and directly controlling the activation of the coupling corresponding to the chosen gear, which is not contiguous with the previous gear.

More particularly, the selective-coupling means BR1, B2, B3, C4, C5, C6 and BR are of the progressive type and are capable of ensuring progressive adaptation between the speed of rotation of a vehicle engine and the speed of the vehicle. The brakes BR1 and BR are capable of serving as a means of progressively setting the vehicle in motion from stationary in first forward gear or respectively in reverse.

To this end, there is an initial situation in which the input element 2 rotates with the engine of the vehicle and the output element 4 is stationary with the wheels of the vehicle, all of the coupling means being deactivated. In order to start the vehicle, the brake BR1 or the brake BR is closed as progressively as wished.

Typically each of the selective-coupling means comprises a wet multi-disc friction device. Each of the two elements to be coupled carries a series of discs. The discs of one of the elements alternate with those of the other element. During the activation, the discs of these two series are pressed against each other by a thrust component (not shown), actuated by pressurization of a hydraulic chamber (not shown). It should be noted that the embodiments described comprise only a single clutch C6, C5 or C4 per axis A31, A32, or A2 respectively carrying a planetary gear set TP1, TP2 or TP3 respectively. This makes possible a significant simplification of the oil supply to the hydraulic chambers of the clutches by a single right or left side of the shafts and by lines (not shown) passing through the centre of the shafts. The hydraulic chambers for the brakes can be supplied through the fixed components such as the frame 1.

In each planetary gear set TP1, TP2 or TP3, the longest forward ratio is obtained by activating a clutch and the shortest ratio is obtained by activation of a brake acting on the ring gear (brake BR1 or B2) or on the sun wheel (brake B3). The braking torque exerted by these brakes is much lower (approximately 1.5 to 2.5 times lower) than the torque transmitted to the output S1, S2 or S3 of the gear set during operation on the corresponding transmission ratio.

Preferably, the majority of the gear ratios obtained by local direct drives C4, C5, C6 have smaller gear reductions (corresponding to longer ratios) than the gears obtained by a selective coupling BR, BR1, B2, B3 acting between the frame and a planetary gear set element.

In the embodiments described here, only the higher gears (4th, 5th and 6th) use a clutch-type coupling, i.e. the gears that produce the lowest torque on the output element 4. The lower gears (REV, 1^{st}, 2^{nd} and 3^{rd}) all use brake-type couplings.

Production is simpler and more robust, as the brakes are easier to control and cool more efficiently due to the fact that they comprise a fixed part connected to the frame.

By limiting the braking requirements at the level of the selective-coupling means, it is also possible to limit hydraulic drag phenomena and the losses and temperature rises due to this drag. It is also possible to limit the hydraulic pressure required for control, and therefore the power of the pump that generates it.

In order to activate a gear of the transmission device, it is sufficient to control the activation of a single one of the selective-coupling means, while releasing the others. Neutral is simply obtained by leaving them all free. When a selective-coupling means is activated, the planetary gear sets that are not associated with this selective-coupling means allow their input and output elements to rotate freely in relation to each other.

In the embodiments described here, the activation of the different brakes and clutches gives the following gears, the values of which are given as examples in the following table in which, for each gear, the value of the gear is given in the column showing the activated selective-coupling means:

| | selective-coupling means | | | | | | |
|---|---|---|---|---|---|---|---|
| gears | BR | B1 | B2 | B3 | C4 | C5 | C6 |
| Reverse gear | 3.94 | | | | | | |
| (REV) | | | | | | | |
| 1^{st} gear | | 4.38 | | | | | |
| 2^{nd} gear | | | 2.59 | | | | |
| 3^{rd} gear | | | | 1.83 | | | |
| 4^{th} gear | | | | | 1.42 | | |
| 5^{th} gear | | | | | | 1.16 | |
| 6^{th} gear | | | | | | | 0.97 |

In comparison with numerous known devices, the invention allows in particular greater flexibility in the choice of gear spacing, combined with a limited space requirement of the device.

In comparison with the teaching of WO 2005/050060 the invention makes it possible in particular to reduce the number of sets of teeth to be produced and to improve the compactness and space requirement of the transmission device.

In these different embodiments, adding an additional gear in the form of an additional local direct drive improves the transmission efficiency. In fact, within a power path, a local direct drive is more efficient than a meshing drive.

Moreover, by limiting the number of gear meshes acting in series in the different power paths 8a, 8b, 8c, the invention makes it possible to limit the transmission losses. In comparison with a conventional transmission as described in EP 0 434 525, for example, a gain of approximately 5% to 6% in efficiency is noted, which is reflected in the performance and consumption of the engine and of the vehicle.

In the third embodiment, which will be described only as regards its differences with respect to the first, there is only a single layshaft 3, having a geometrical axis A3, and which has a drive connection to the ring gear CDiff by a single meshing pinion PA. This embodiment is preferred for applications in which a little more axial length is acceptable, but where the radial space requirement must be limited, in particular towards the bottom of the vehicle in order to avoid the gearbox reducing the ground clearance of the vehicle.

The downstream planetary gear sets TP1 and TP2 are both installed on the shaft 3 about the axis A3, along which they are aligned. The output elements S1 and S2 of the gear sets TP1 and TP2 are connected for common rotation with the layshaft 3.

The upstream transfers TR1 and TR2 are situated axially on either side of the upstream planetary gear set TP3 which remains centred on the upstream rotary element 2. The planetary gear sets TP1 and TP2 are both situated axially between the transfers TR1 and TR2.

The driven transfer pinion T33 of the third meshing transfer TR3 is rotatably integral with the layshaft 3. It would have been possible to fix the driven transfer pinion T33 directly on the shaft 3, as shown by the chain dotted line 71.

However, according to an advantageous feature of this embodiment, the driven transfer pinion T33 is integral with the planet carrier of one of the planetary gear sets TP1, TP2 mounted on the layshaft 3, this planet carrier being itself integral with the layshaft 3 as it forms the output element of the planetary gear set TP1 or TP2 in question.

In the example shown, the driven pinion T33 is integral with the planet carrier PS2 of the gear set TP2 which is situated axially between the meshing pinion PA and the other gear set TP1 arranged about the layshaft 3.

The planets 121 of the planet carrier PS2 integral with the driven transfer pinion T33 are situated axially between on the one hand the connection of the planet carrier PS2 to the layshaft 3 and on the other hand the connection of the planet carrier PS2 to the driven transfer pinion T33. Said transfer pinion T33 is itself situated axially between on the one hand the planets 121 and on the other hand the selective-coupling means C5 and B3 associated with this gear set. Thus, the transfers TR2 and TR3 are axially very close to each other at one end of the gearbox, in this example, the end adjacent to the motive power source 6 and the meshing pinion PA.

The mounting of the gear set TP3 on the input element 2 is reversed in comparison with that in FIG. 1. Starting from the left hand side (side of the motive power source 6), are firstly, the output element S3, then the fourth epicyclic gear set 141, 142, 143, then the third epicyclic gear set 131, 132, 133. The selective-coupling means are also in reverse order along the axis A2: from left to right are the brake BR1, the brake BR and the clutch C4.

The mounting of the gear set TP1 is also reversed, the transfer TR1 is now on the right and the selective-coupling means C6, B2 are now on the left.

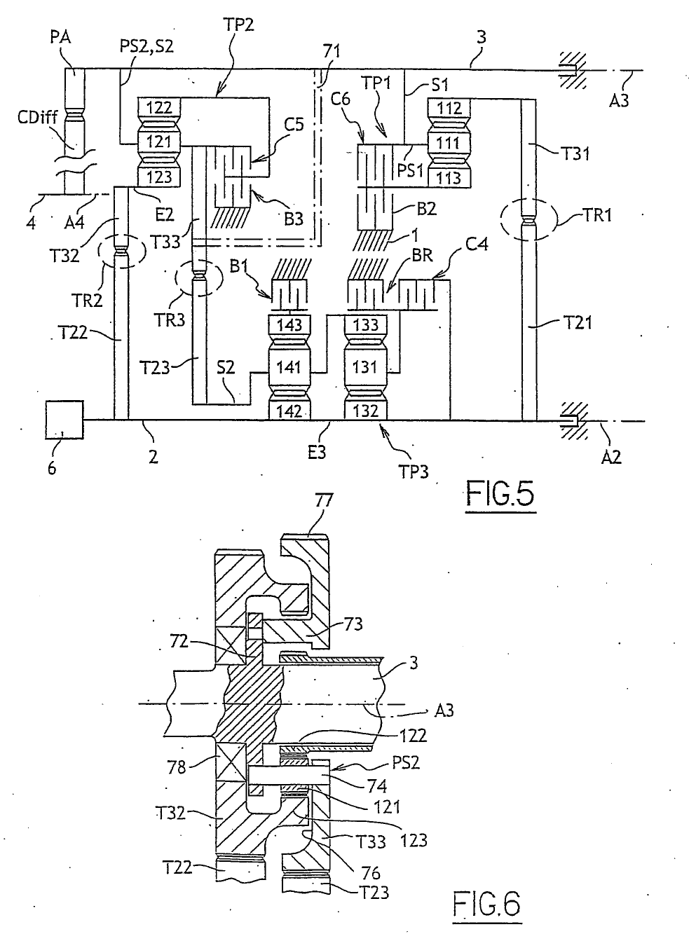

Moreover, as shown in FIG. 5, in order to limit the axial length, the selective-coupling means of each gear set TP1, TP2 are now around each other instead of being aligned axially. More precisely, for each gear set, the brake surrounds the clutch, i.e. B3 surrounding C5 and B2 surrounding C6. All of the planetary gear sets and the coupling elements, as well as the transfer TR3, are accommodated axially between the transfers TR1 and TR2.

The axes A2, A3 and A4 are at the vertices of a triangle when they are viewed end-on (not shown).

FIG. 6 shows a specific embodiment in which the planet carrier PS2 is formed by a flange 72 of the shaft 3, and by the driven transfer pinion T33 rigidly fixed to the flange 72 by essentially axial pillars 73 distributed angularly about the axis A3. The pillars alternate circumferentially with journals 74 fixed to the flange 72 and to the pinion T33. The pinion T33 is significantly recessed in the whole of its central region 76 to accommodate the ring gear 123. Thus the outside toothing 77 of the pinion T33, which meshes with the driving transfer pinion T23, is arranged around the planetary gear set TP2, practically without axial offset in relation to the planetary gear set. The ring gear 123 is formed by a lateral collar on the driven transfer pinion T32, supported rotatably on the layshaft 3 by means of a bearing 78 backing onto the flange 72.

The operation of the embodiment in FIGS. 5 and 6 is approximately the same as that of the embodiment in FIGS. 1 and 2. In particular, each gear is obtained by activating the same selective-coupling means as in FIG. 1, respectively. When the gear set TP3 is activated, (BR1, BR or C4 activated), the torque is transmitted to the meshing pinion PA via the planet carrier PS2 and the layshaft 3. The planet carrier PS2 thus acts as a transmission part between the driven transfer pinion T33 and the layshaft 3.

Of course the invention is not limited to the examples that have just been described and numerous amendments can be made to these examples without exceeding the scope of the invention.

It would be possible to run at least one of the epicyclic gear sets either in a local direct drive gear or in an overdrive gear, for example by connecting the input of the gear set to its planet carrier, while the sun wheel and the ring gear are linked one to the output and the other to a brake.

It is moreover possible to envisage a fourth embodiment of the invention, similar to the first embodiment but without the second planetary gear set TP2 without the second meshing transfer TR2, without the second layshaft 32, without the ring gear CDiff and without the output pinions PA1 and PA2. The gear ratios delivered by the two other gear sets are then chosen accordingly. In the fourth embodiment, the first layshaft 31 is therefore directly replaced by the downstream rotary element 4 integral with the toothed wheel T33 and about which the first planetary gear set TP1 would be mounted. This embodiment does not require a layshaft. Similarly, it is possible to modify the third embodiment so that the layshaft 3 forms the downstream element of the gearbox.

It is very clear that a device according to the invention can also be used in the other direction, in overdrive, and that the terms “upstream” and “downstream” can be exchanged in other configurations.

In the second embodiment, the chain T63 can be replaced by an intermediate pinion meshing with T23 and with T53 which would then be meshing pinions and no longer chain pinions.

In the third embodiment, it is possible to modify the arrangement in various ways: it is possible for example to arrange the gear set TP3 such as in FIG. 1, with the output S3 on the right-hand side and use the planet carrier PS1 such as a transmission part between the driven transfer pinion T33 and the layshaft 3. The transfer TR3 would then be situated axially between on the one hand the transfer TR1 and on the other hand the pinions 111, 112, 113.

Conversely, it is possible to leave the gear set TP3 arranged as shown in FIG. 5 but to invert the gear sets TP1 and TP2 along the axis A3, so that the planet carrier PS1 forms, as in the previous variant, the transmission part between T33 and the shaft 3.

It is also possible to provide two upstream planetary gear sets aligned along the axis A2.

1. A Multiple-ratio transmission device comprising:
a frame (1);
an upstream rotary element (2) and a downstream rotary element (4);
a downstream planetary gear set (TP1; TP2) and an upstream planetary gear set (TP3) which are non-coaxial and belong to two different power paths (8a; 8b and 8c) between the upstream rotary element and the downstream rotary element;
an upstream meshing transfer (TR1, TR2), interposed between the upstream rotary element (2) and the downstream planetary gear set (TP1, TP2)
a downstream meshing transfer (TR3) interposed between the upstream planetary gear set (TP3) and the downstream rotary element (4); and
selective-coupling means (BR1 to B3, BR, C4 to C6) to make each planetary gear set operate selectively in local direct drive or in at least one different transmission ratio;
characterized in that the upstream planetary gear set (TP3) is mounted about the shaft (A2) of the upstream rotary element (2).

2. A device according to claim 1, characterized in that at least one of the transfers (TR1, TR2) is placed axially between at least one of the planetary gear sets (TP1, TP2, TP3) and an extremity (5) of the upstream element (2), said extremity for mechanical connection of the upstream element to a motive power source (6).

3. A device according to claim 1, characterized in that the two transfers are arranged in two planes perpendicular to the axis (A2) of the upstream rotary element, and the two planetary gear sets are accommodated spatially between these two planes.

4. A device according to claim 1, characterized in that the upstream transfer (TR2) comprises a toothed wheel (T22) integral with the upstream rotary element (2), in that the downstream planetary gear set (TP1; TP2) is mounted about an axis (A31; A3) of a layshaft (31; 3), and in that the downstream transfer (TR3) comprises a toothed wheel (T23) mounted about the axis (A2) of the upstream rotary element and connected, preferably by a chain (T62) or by an intermediate pinion, to a toothed wheel (T53) integral with the downstream rotary element (4).

5. A device according to claim 1, characterized in that the upstream transfer (TR2) comprises a driving toothed wheel (T22) rotatably integral with the upstream rotary element (2), in that the downstream planetary gear set (TP1; TP2) is mounted about an axis (A31; A3) of a layshaft (31; 3), and in that the downstream transfer (TR3) comprises a driven toothed wheel (T33) rotatably integral with the layshaft (31; 3).

6. A device according to claim 1, characterized in that a toothed wheel (T33) of a transfer (TR3) associated with one (TP3) of the planetary gear sets mounted about one (2) of the shafts, is rotatably integral with one (3) of the shafts while being fixed to a planetary gear set (TP2) element (S2) rotatably integral with this shaft (3).

7. A device according to claim 6, characterized in that said planetary gear set element (S2) is a planet carrier (PS2) the planets (121) of which are installed axially between on the one hand the connection with said other shaft (3) and on the other hand said toothed wheel of a transfer (TR3).

8. A device according to claim 7, characterized in that the planet carrier (PS2) is formed by said toothed wheel (T33) of a transfer (TR3) fixed to a flange (72) of said other shaft (3) by pillars (73) which alternate circumferentially with journals (74) carrying the planets (121).

9. A transmission device according to claim 1, characterized in that the device comprises between the upstream rotary element (2) and the downstream rotary element (4) an additional power path comprising an additional planetary gear set (TP1) axially aligned with one of the two, downstream (TP2) and respectively upstream (TP3), planetary gear sets.

10. A transmission device according to claim 9, characterized in that the planetary gear sets (TP1, TP2, TP3) are mounted axially between the meshing transfers (TR1, TR2) associated with the two aligned planetary gear sets (TP1, TP2), as well as the transfer (TR3) associated with the third gear set (TP3).

11. A transmission device according to claim 1, characterized in that said downstream planetary gear set is a first downstream planetary gear set, in that the device comprises between the upstream rotary element (2) and the downstream rotary element (4) at least one third power path (8c) comprising a second downstream planetary gear set (TP2), having an axis (A32) different from those (A31, A2) of the first downstream planetary gear set (TP1) and of the upstream planetary gear set (TP3), the second downstream planetary gear set (TP2) being mounted operatively in series with a second upstream meshing transfer (TR2) defining between the upstream rotary element (2) and the downstream rotary element (4), when the second downstream planetary gear set (TP2) is in a local direct drive state, a transmission ratio different from each of those defined by the two above-mentioned meshing transfers (TR1, TR3) when their respective planetary gear set (TP1, TP3) is in a local direct drive state.

12. A device according to claim 11, characterized in that the first downstream planetary gear set is mounted about an axis (A31) of a first layshaft (31), and in that the second downstream planetary gear set (TP2) is mounted about an axis (A32) of a second layshaft (32), the first and the second downstream planetary gear sets being connected, at least indirectly, respectively to the first and second layshafts, the first and second layshafts being connected to the downstream rotary element (4) by meshing (PA1, PA2).

13. A device according to, claim 12, characterized in that the first layshaft (31) and the second layshaft (32) each comprise a pinion (PA1, PA2) mounted along the respective axis (A31, A32) of the layshaft (31, 32), the pinions meshing with a single toothed wheel (CDiff) on the downstream rotary element (4).

14. A device according to claim 11, characterized in that the first downstream transfer (TR1) and the second downstream transfer (TR2) comprise a common toothed wheel (T21, T22) on the upstream rotary element (2), meshing with two driven pinions (T31, T32) each mounted along a respective axis (A31, A32) of the first and second downstream planetary gear sets (TP1, TP3).

15. A device according to claim 14, characterized in that the common toothed wheel comprises two toothings of different diameters each meshing with a respective driven pinion (T31, T32).

16. A device according to claim 11, characterized in that the second downstream transfer (TR2) and one of the first downstream transfer (TR1) and the upstream transfer (TR3) are arranged in two planes perpendicular to the axis (A2) of the upstream rotary element, and the second downstream planetary gear set (TP2) is accommodated spatially between these two planes.

17. A device according to claim 9, characterized in that the three planetary gear sets comprise:
a planetary gear set (TP1), preferably downstream, the input (E1) of which is connected to a sun wheel (112) and the output (S1) of which is connected to a planet carrier (PS1), this gear set being capable of local direct drive to produce a sixth gear, and a gear reduction by locking a ring gear (113) to produce a second gear;
another planetary gear set (TP2), preferably downstream, the input (E2) of which is connected to a ring gear (123) and the output (S2) of which is connected to a planet carrier (PS2), this gear set being capable of direct local drive to produce a fifth gear, and a gear reduction by locking a sun wheel (122) to produce a third gear; and
a further preferably upstream planetary gear set (TP3), the input (E3) of which is connected to a sun wheel (142) and the output (S3) of which is connected to a planet carrier (PS4), this further gear set being capable of a local direct drive to produce a fourth gear, and a gear reduction by locking a ring gear (143) to produce a first gear;
the gear ratios being increasingly long from first to sixth gear.

18. A device according to claim 1, characterized in that one (TP3) of the planetary gear sets comprises at least two epicyclic gear sets having a common input (E3) and a common output (S3).

19. A device according to claim 18, characterized in that a first (131 to 133) of these epicyclic gear sets has a planet carrier (PS3) free in relation to the common input (E3) and to the common output (S3) and capable of being immobilized in relation to the frame by means of one of the selective-coupling means (BR) in order to produce a reverse gear,
a second (141 to 143) of these epicyclic gear sets having a planet carrier (PS4) constantly connected to one (S3) of said common input and output,
said one of the planetary gear sets being capable of producing in addition to the reverse gear, two forward gears, each by activation of a respective (BR1, C4) selective-coupling means.

20. A device according to claim 19, characterized in that said one of the planetary gear sets is the upstream planetary gear set (TP3), the first and second epicyclic gear sets having sun wheels (132, 142) connected to the common input (E3) and integral with the upstream rotary element (2), the planet carrier (PS4) of the second epicyclic gear set being constantly connected to the common output (S3) and to a ring gear (133) of the first epicyclic gear set.

21. A device according to claim 1, characterized in that one of the planetary gear sets comprises a sun wheel (131) connected to the input (E3), a ring gear (133) connected to the output (S3), and a planet carrier (PS3) capable of being selectively locked to produce a reverse gear.

22. A device according to claim 1, characterized in that the axes of two of the planetary gear sets are substantially parallel, and in that these two planetary gear sets are mutually aligned approximately perpendicularly to their axes.

23. A device according to claim 1, characterized in that at least one of the planetary gear sets (TP1; TP2; TP3) comprises an epicyclic gear set comprising:
a planet carrier (PS1; PS4; PS3) constantly connected at least indirectly to a first (4) of the upstream and downstream rotary elements, and capable of being selectively connected, at least indirectly, to the second (2) of said upstream and downstream rotary elements by one (C6; C4; C5) of the selective-coupling means, thus creating a local direct drive;
a sun wheel (112; 122; 142) and a ring gear (113; 123; 143) one of which (112; 123; 142) is constantly connected to said second rotary element (2); and the other (113; 122; 143) of which can be connected selectively to the frame (1) by one (B2; BR1; B3) of the selective-coupling means.

24. A device according to claim 1, characterized in that each transmission ratio is produced by closing a single selective-coupling means of one of the planetary gear sets (TP1, TP2, TP3) and by placing or maintaining in an open state the other selective-coupling means of the transmission device.

25. A device according to claim 1, characterized in that the selective-coupling means (BR1 to B3, C4 to C6, BR) are of the progressive type and are capable of ensuring progressive adaptation between the speed of rotation of a vehicle engine and the speed of the vehicle, in particular for setting the vehicle in motion from stationary by at least one of the selective-coupling means.

26. A device according to claim 1, characterized in that the planetary gear sets (TP1 to TP3) and the transfers (TR1 to TR3) are constantly meshed.

27. A device according to claim 1, characterized in that the shortest of the ratios obtained by local direct drives (C4, C5, C6) is longer than the longest of the ratios obtained by selective-coupling (BR, BR1, B2, B3) between the frame (1) and an element of a planetary gear set.
